(19) United States
(12) Patent Application Publication
(10) Pub. No.: US 2002/0108291 A1
(43) Pub. Date: Aug. 15, 2002

(54) Protective fishing reel cover

(76) Inventor: Monti Kay Ladd, San Juan Capistrano, CA (US)

Correspondence Address: Monti Kay Ladd, 31121 Calle Santa Rosalia, San Juan Capistrano, CA, 92675, US

(21) Appl. No.: 09/781,716

(22) Filed: Feb. 12, 2001

(51) Int. Cl. A01K 97/08

(52) U.S. Cl. 43/26

(57) ABSTRACT

A conical shaped, protective fishing reel cover including a circular end, elliptical end and a lateral closure with a resealing fastener system adjacent to a small lateral opening that can encompass the fishing reel and associated fishing reel crank congruently whether the fishing reel is mounted to a fishing rod or separated from the fishing rod.

### STATEMENT REGARDING FEDERALLY SPONSORED RESEARCH AND DEVELOPMENT

Not Applicable

### CROSS-REFERENCE TO RELATED APPLICATIONS

Not Applicable

### REFERENCE TO A MICROFICHE APPENDIX

Not Applicable

### BACKGROUND OF THE INVENTION

1. Field of the Invention

This invention relates to protective fishing reel covers, more specifically, a flexible cover that can encompass a fishing reel and an associated fishing reel crank simultaneously whether the fishing reel is mounted to or detached from a fishing rod.

2. Description of the Prior Art

Fishing reels have become more advanced in design, in turn; moving and intricate parts made of high quality and expensive materials are utilized. Exposure to saltwater, ultra violet rays and other harmful elements can cause damage to the fishing reel. Moving parts, such as a fishing reel crank, can be accidentally manipulated when the fishing reel is inadequately protected. The demand for convenient, economical protection that encompasses the fishing reel and fishing reel crank whether the fishing reel is mounted or detached from the fishing rod still exists.

U.S. Pat. No. 4,876,819, issued to Clifford discloses a protector with several pockets connected with an extended member and encircled with an elastic band. The pockets accommodate the spool part or the entire fishing reel and the elastic band helps keep the protector in place. This cover can encompass the entire fishing reel, but is not contoured to stabilize the fishing reel crank.

U.S. Pat. No. 5,501,029, issued to McDaniel discloses a flexible body member that can be formed into a cylindrical shape to encircle only the face portion of the fishing reel while it is mounted to the fishing rod. This method of protection leaves the fishing reel crank exposed and unprotected.

U.S. Pat. No. 4,136,478, issued to Wycosky, discloses a cover that has a receptacle, which is placed over the handle portion of the fishing rod on which the fishing reel is mounted, covering both the fishing reel and the fishing rod handle. This invention's intended use is for the fishing reel only when it is mounted to the fishing rod.

U.S. Pat. No. 5,956,885, issued to Zirbes, discloses a cylindrical cover of a clam shell design placed around the fishing reel while mounted to the fishing rod leaving the fishing reel crank exposed and unprotected.

### SUMMARY OF THE INVENTION

The present invention provides a protective fishing reel cover to encompass a fishing reel when mounted to a fishing rod and equally encompass the fishing reel when it is detached from the fishing rod. A basic concept of the present invention is to provide a flexible covering that encompasses the entire fishing reel and it's associated fishing reel crank simultaneously. The conical shaped main body provides a lateral opening to accommodate a fishing reel foot when the fishing reel is mounted to the fishing rod. Adjacent to the lateral opening, are two overlapping, lateral extensions featuring a hook and loop fastener system that creates a closure for securing the fishing reel inside the fishing reel cover. The circular end of the fishing reel cover is adjacent to the lateral opening and is properly shaped to contour the cylindrical end of the fishing reel. The opposing end of the fishing reel cover is elliptical in shape to accommodate and stabilize the fishing reel crank when the fishing reel cover encompasses it.

It is an object of the present invention to provide an easily applied, flexible and protective fishing reel cover.

It is also an object of this invention to provide a protective fishing reel cover that will easily encompass all parts of the fishing reel and the fishing reel crank simultaneously.

Another object of this invention is to accommodate and provide effective protection to the fishing reel when it is mounted to the fishing rod and equally accommodate the fishing reel when it is detached from the rod.

An additional object of the invention is to stabilize the movable parts of the fishing reel, specifically the fishing reel crank.

Further objects and advantages of the present invention will become apparent from the following detailed description of the invention when considered with the accompanying drawings.

### BRIEF DESCRIPTION OF THE DRAWINGS

FIG. 1 is a view of the protective fishing reel cover encompassing a phantom view of a fishing reel mounted to a fishing rod.

FIG. 2 is an exploded view of the protective fishing reel cover.

FIG. 3 is a perspective view of the protective fishing reel cover showing the elliptical end and underside of the conical main body.

FIG. 4 is a perspective view of the protective fishing reel cover from the circular end showing the top side of the conical main body.

FIG. 5 is an underside view of the protective fishing reel cover displaying the lateral opening and closure of the conical main body.

FIG. 6 is an underside view of the protective fishing reel cover with a phantom view of the fishing reel and the associated fishing rod.

### DETAILED DESCRIPTION OF THE INVENTION

Nomenclature

10 Protective fishing reel cover

12 Conical main body

14 Elliptical end

16 Circular end

18 Lateral opening

20 Lateral closure

22 Upper extension of the lateral closure

24 Under extension of the lateral closure

26 Loop section of a hook and loop fastener system

28 Hook section of a hook and loop fastener system

30 Fishing reel

32 Fishing rod

34 Reel crank

36 Reel foot

Construction

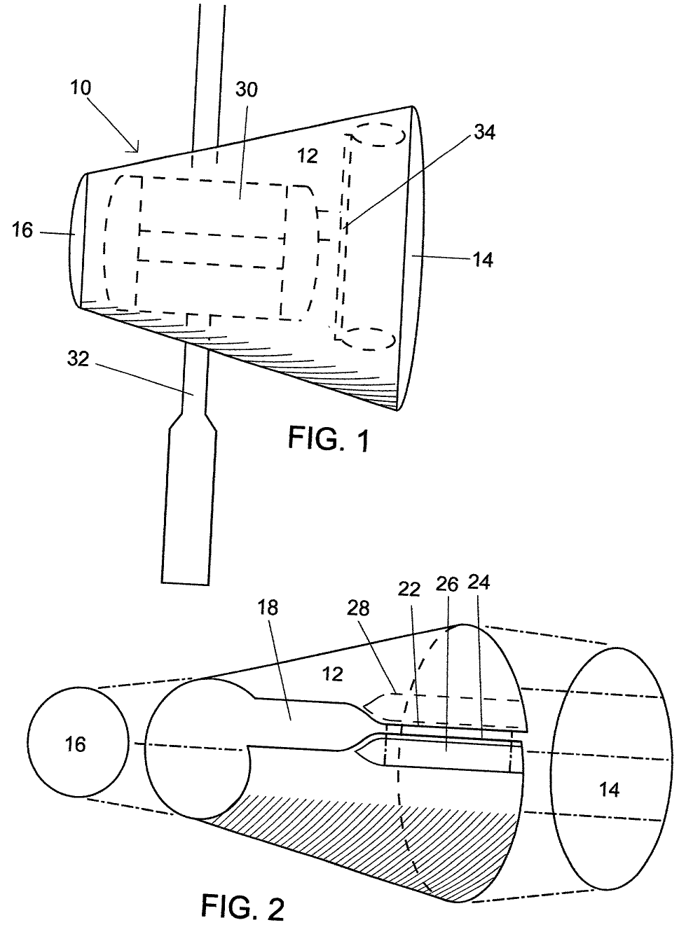

The presently preferred embodiment according to this invention is shown in FIGS. 1-6. A protective fishing reel cover 10 for enclosing a fishing reel 30 and an associated reel crank 34 includes a conical main body 12, a circular end 16 and an opposing elliptical end 14.

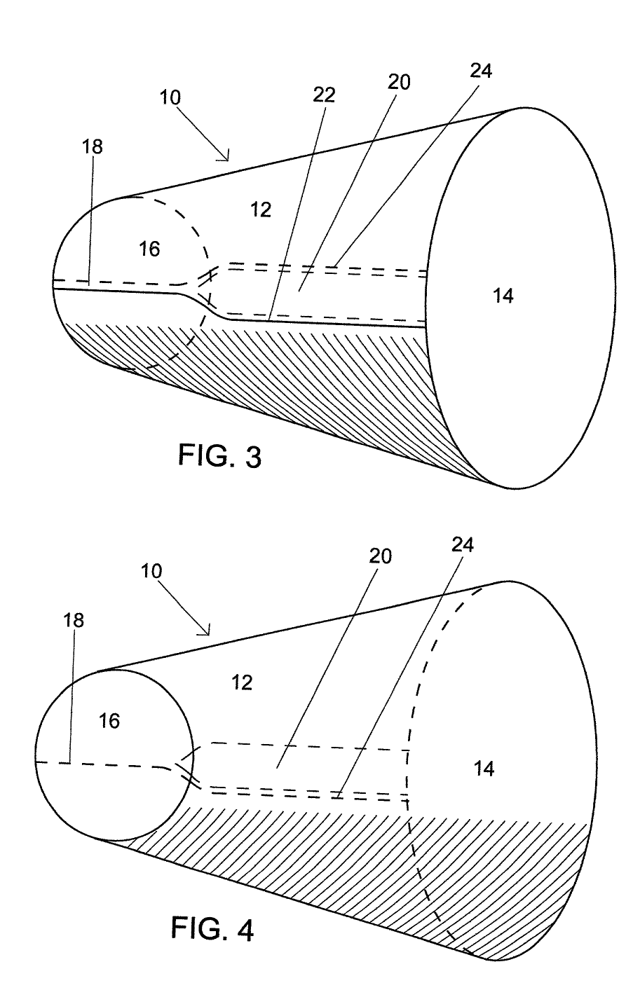

FIG. 2 depicts the conical main body 12 of the protective fishing reel cover 10 configured into a cylindrical form, which is smaller at one end than the opposing end. The lateral edges of the conical main body 12 feature an upper extension of a lateral closure 22 placed on top of an opposing under extension of a lateral closure 24. A loop section of a hook and loop fastener system 26 is attached to the upper extension of the lateral closure 22. A hook section of a hook and loop fastener system 28 is attached to the under extension of the lateral closure 24. The loop section of a hook and loop fastener system 26, attached to the upper extension of the lateral closure 22, can be joined and released with the hook section of the hook and loop fastener system 28 attached to the under extension of the lateral closure 24. This creates a resealing lateral closure 20, as shown in FIGS. 3-6.

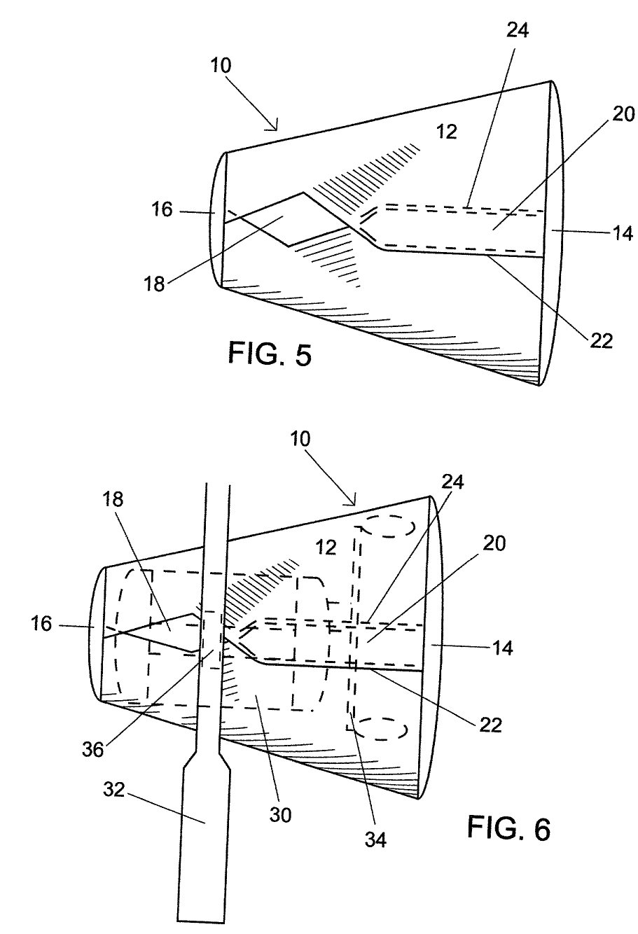

Preceding the lateral closure 20 and positioned adjacent to the circular end 16 of the protective fishing reel cover 10, is a lateral opening 18 which is created by the omission of extensions and a hook and loop fastener system along the lateral edges of the conical main body 12. This lateral opening 18 is specifically designed to accommodate a reel foot 36 of the fishing reel 30 when it is mounted to a fishing rod 32. FIGS. 5-6 show the underside view of the protective fishing reel cover 10 depicting the lateral closure 20 in the closed position and the lateral opening 18 in the open position to accommodate the reel foot 36 when the fishing reel 30 is attached to the fishing rod 32.

The circular end 16 of the protective fishing reel cover 10 is attached to the smaller end and adjacent to the lateral opening 18 of the conical main body 12, as shown in FIGS. 1-6. The circular end 16 is specifically shaped to contour the cylindrical shape of the fishing reel 30 when it is enclosed inside the protective fishing reel cover 10. This configuration deters shifting and movement of the fishing reel 30 when it is inside the protective fishing reel cover 10. The elliptical end 14 is attached to the larger end of the conical main body 12, located opposite the circular end 16 and adjacent to the lateral closure 20 of the protective fishing reel cover 10. The elliptical end 14 is specifically shaped to prohibit the rotational, circular movement of the reel crank 34 while it is enclosed inside the protective fishing reel cover 10. FIG. 1 shows the fishing reel 30 and it's placement, more specifically, it's relationship with the circular end 16, the elliptical end 14 and the conical main body 12 when it is enclosed inside the protective fishing reel cover 10.

The preferred method of assembly of the protective fishing reel cover 10 is sewing. Additional methods of assembly include, but are not limited to thermal welding, taping and adhesive bonding. The present invention is preferably made of a water-repellent material such as; rubber, vinyl and treated leather. Additional mterials such as; elastomeric material, knitted or woven nylon, polyester, or cotton fabrication may also be utilized. The hook and loop fastener system is the preferred method of the resealing lateral closure 20. Other types of closures may also be used including specifically, but not exclusively, buttons, hook and eyelet combinations, snaps and separating zippers.

Use

The protective fishing reel cover 10 encompasses the fishing reel 30 and the reel crank 34 by, first, positioning the elliptical end 14 over the reel crank 34, second, encompassing the associated fishing reel 30 and, finally, joining the hook and loop fastener system of the lateral closure 20. The protective fishing reel cover 10 may be used to encase the fishing reel 30 while it is mounted to the fishing rod 32, or when it is detached from the fishing rod 32. The lateral opening 18 accommodates the reel foot 36 when the fishing reel 30 is mounted to the fishing rod 32. The circular end 16, the elliptical end 14, and the conical main body 12 function cohesively to stabilize and prevent accidental movement of the fishing reel 30 and the associated reel crank 34 while encompassed inside the protective fishing reel cover 10. The material comprising the protective fishing reel cover 10 protects the fishing reel 30 and all associated parts from exposure to saltwater, ultra violet rays, boat cleansers, impact, scratches and other harmful elements. The protective fishing reel cover 10 may be produced to fit any size fishing reel 30.

Although the description above contains many principles, which illustrate some of the presently preferred embodiments of this invention, it will be understood by those skilled in the art that various changes and modifications may be made therein without departing from the scope of the invention.

I claim:

1. A protective fishing reel cover, comprising:
(a) a conical main body defining a protective compartment and providing extensions on both upper and under lateral edges adjacent to the largest end of the conical main body whereby overlapping of the extensions provide a lateral closure and;
(b) the remaining part of said lateral edges on the opposite end of said main body wherein said extensions are omitted provide a lateral opening;
(c) a circular end member attached to and enclosing the smaller end of the conical main body;
(d) an elliptical end member attached to and enclosing the larger end of the conical main body and;
(e) a means for securing and releasing said upper and under extensions of the lateral closure;
(f) whereby the extensions of the lateral closure can be released to allow the insertion of a fishing reel into said compartment, and the secured position of the extensions provide a protective surrounding for the fishing reel within said compartment.

2. A protective fishing reel cover according to claim 1 provides a resealing means for securing and releasing the lateral closure comprised of a hook and loop fastener system.

3. A protective fishing reel cover according to claim 1 wherein the conical main body allows said reel cover to encompass said reel while allowing an associated reel foot to pass through the lateral opening.

4. A protective fishing reel cover according to claim 2 wherein said reel cover protectively encompasses said reel while it is mounted to a fishing rod and equally encompasses said reel when it is separated from said rod.

5. A protective fishing reel cover of claim 1 wherein the conical main body, the circular end and the elliptical end comprise a compartment capable of encompassing the entire fishing reel and the associated reel crank congruently.

6. A protective fishing reel cover according to claim 5 wherein the specific shape of said fishing reel cover stabilizes the associated reel crank of the fishing reel.

7. A protective fishing reel cover of claim 1 wherein the conical main body, the circular end and the elliptical end are constructed of a water resistant, flexible material.
